(19) United States
(12) Patent Application Publication
(10) Pub. No.: US 2026/0269322 A1
(43) Pub. Date: Sep. 10, 2026

(54) TFSI-BASED SALTS AND POLYMER ELECTROLYTES AND THEIR USE IN LITHIUM-ION BATTERIES

(71) Applicant: UT-Battelle, LLC, Oak Ridge, TN (US)

(72) Inventors: Michelle Lehmann, Knoxville, TN (US); Tomonori Saito, Knoxville, TN (US)

(21) Appl. No.: 19/558,714

(22) Filed: Mar. 6, 2026

Related U.S. Application Data
(60) Provisional application No. 63/768,231, filed on Mar. 7, 2025.

(51) Int. Cl. H01M 10/0568; H01M 10/0525; H01M 10/0569

(52) U.S. Cl. CPC H01M 10/0568; H01M 10/0525; H01M 10/0569; H01M 2300/0051

(57) ABSTRACT

An electrolyte compound having the following structure:

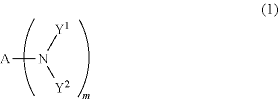

wherein: A is a linear, branched, or cyclic hydrocarbon group containing at least one carbon atom and optionally containing one or more heteroatoms selected from N, O, and S; Y¹ and Y² are independently selected from H atom and a sulfonylimide group of the formula

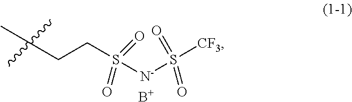

wherein B⁺ is an alkali metal ion; wherein at least one of Y¹ and Y² is said sulfonylimide group; and m is an integer of at least 1. Also described herein is an electrolyte solution containing the above described electrolyte compound dissolved in or plasticized with a solvent, as well as lithium-based batteries comprising: a) an anode; (b) a cathode; and (c) the electrolyte solution described above in contact with the anode and cathode.

### CROSS REFERENCE TO RELATED APPLICATION

The present application claims benefit of U.S. Provisional Application No. 63/768,231, filed on Mar. 7, 2025, all of the contents of which are incorporated herein by reference.

### GOVERNMENT SUPPORT

This invention was made with government support under Prime Contract No. DE-AC05-00OR22725 awarded by the U.S. Department of Energy. The government has certain rights in the invention.

### FIELD OF THE INVENTION

The present invention generally relates to electrolyte compositions for batteries, particularly lithium-based batteries. The present invention is more particularly directed to TFSI-based electrolyte salts and single-ion conducting (SIC) polymers for batteries, particularly lithium-based batteries. The present invention is also directed to lithium-based batteries containing a TFSI-based electrolyte salt or SIC polymer.

### BACKGROUND

Conventional liquid electrolytes for lithium-ion and sodium-ion batteries contain a salt in liquid solution (e.g., Gen2 electrolyte for Li-ion batteries is 1.2M LiPF₆ in ethylene carbonate: ethylmethyl carbonate, EC: EMC 3:7 w/w). Liquid electrolytes exhibit high bulk ionic conductivity, but much of the conductivity is contributed by the anion resulting in a low cation transport number (t⁺)(below 0.3). The low cation transport number results in concentration polarization at the electrodes, a reduced electrochemical stability window, and dendrite formation, all of which limits their practical application for high energy density batteries utilizing an alkali metal anode.

Single-ion conducting polymeric (SICP) materials constrain the mobility of the anion by tethering it to the polymer and often exhibit a much higher cation transport number (>0.85), such as described in H. D. Nguyen et al., Energ. Environ. Sci., 11(11), 3298-3309, 2018. SICPs can form a solid or quasi-solid-state electrolyte with a high transport number and offer a potential route for the realization of next-generation batteries with higher energy density, longer cycle life, and improved safety over the conventional Li-ion batteries with liquid electrolytes. Over the last several decades, many types of SICPs with various tethered anionic structures have been studied to this end. Examples of these tethered anions include phosphate, sulfonate, and trifluoromethanesulfonimide (TFSI). However, the conductivity of conventional SICP electrolytes is often too low to be utilized in practical applications (10⁻¹¹ to 10⁻⁶ S/cm at 30° C.)(e.g., R. Bouchet et al., Nat. Mater., 12(5), 452, 2013). Thus, an SICP material that could provide a high cation transport number while maintaining a more suitable level of conductivity would represent a significant advance in the art of lithium-ion batteries.

### SUMMARY

In one aspect, the present disclosure is directed to novel electrolyte compounds, including both small non-polymeric TFSI-based compounds and polymeric SICPs, that can advantageously possess one or more of the following properties: (i) a high lithium-ion conductivity (e.g., at least or above 1.0×10⁻⁹ S/cm at 80° C.); (ii) high cation transport number (e.g., at least or above 0.85), and (iii) low melting point or glass transition temperature (T_{g}), e.g., below 100° C. When incorporated into a lithium-ion battery as an electrolyte, the electrolyte compound is typically dissolved in or plasticized with a solvent suitable for use in a lithium-ion battery. The solvent or plasticizer may be, for example, a carbonate, ether, polyethylene glycol, nitrile, or sulfone solvent, or a combination of any two or three of these.

The electrolyte compounds described herein have the following structure:

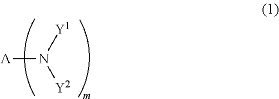

wherein: A is a linear, branched, or cyclic hydrocarbon group containing at least one carbon atom and optionally containing one or more heteroatoms selected from N, O, and S; Y¹ and Y² are independently selected from H atom and a sulfonylimide group of the formula

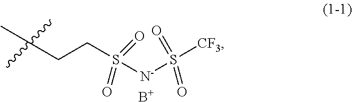

wherein B⁺ is an alkali metal ion or more particularly a lithium ion; wherein at least one of Y¹ and Y² is the sulfonylimide group; and m is an integer of at least 1.

As discussed later on in this disclosure, the electrolyte compounds were herein synthesized utilizing a green Micheal-Addition reaction with an amine-based small molecule or polymer. The amine-based trifluoromethanesulfonimide (TFSI) small molecule salt exhibits a bulk conductivity similar to that of conventional LiTFSI salt but with a significantly improved cation transport number in a liquid electrolyte system. In some embodiments, the cation transport number of the electrolyte compound in a liquid electrolyte system may be 4× or 5× the cation transport number of a conventional LiTFSI salt. As demonstrated later in this disclosure, the electrolyte compounds disclosed herein may exhibit improved Li⁺ conductivity compared to single-ion homopolymers of styrene TFSI and methacrylate TFSI. Additionally, when a liquid electrolyte is added to the single-ion conducting polymer, high ionic conductivity can be achieved with an increase (e.g., 4× or higher) in the cation transport number compared to the liquid system alone.

In another aspect, the present disclosure is directed to lithium-ion batteries containing any of the above-described electrolyte compounds. The lithium-ion battery includes: a) an anode; (b) a cathode; and (c) an electrolyte solution in contact with the anode and cathode, wherein the electrolyte solution contains the electrolyte compound within the scope of Formula (1) as described above, dissolved in or plasticized with a solvent suitable for a lithium-ion battery. Although the present disclosure focuses on lithium-based batteries, the electrolyte compositions described herein may be applicable to ion-type batteries beyond lithium, including alkali metal batteries (e.g., sodium and potassium), alkaline earth batteries (e.g., magnesium and calcium), and others (e.g., zinc and aluminum).

### BRIEF DESCRIPTION OF THE DRAWINGS

FIGS. 1a-1c. FIG. 1a provides a schematic synthesis of VTFSI and PAATFSI. FIG. 1b schematically shows a fabrication process of a glass fiber composite polymer electrolyte. FIG. 1c shows some of the benefits of the PAATFSI polymer electrolyte.

FIGS. 2a-2e. FIG. 2a presents ¹H NMR spectra of VTFSI K⁺ (upper, DMSO-d6), PAA (middle, D₂O), and PAATFSI (lower, DMSO-d6). FIG. 2b is a graph showing Li-ion conductivity of dry homopolymer electrolytes. FIG. 2c is a graph showing DSC curves of PAATFSI plasticized with PAATFSI and PEG. FIG. 2d is a graph showing TGA profiles of PAATFSI samples (plasticized and unplasticized). FIG. 2e is a graph showing DSC curves of PAATFSI plasticized with EC and PC. Notably, in FIGS. 2a and 2e, the vertical lines indicate the glass transition temperatures.

FIGS. 3a-3b. FIG. 3a is a graph showing Li-ion conductivity as a function of inverse temperature for the plasticized PAATFSI samples. FIG. 3b is a graph showing Li-ion conductivity as a function of temperature normalized to T_{g} of the samples.

FIGS. 4a-4e. FIGS. 4a and 4b are Nyquist plots of PAATFSI EC/PC60 samples (with an without salt, respectively) in Li|Li symmetric cells before stripping/plating cycles at 30° C. FIG. 4c shows an image of glass mesh and PAATFSI-infused glass mesh utilized in coin cell evaluations. FIG. 4d is a graph showing cycling performance of samples in Li|Li symmetric cells with stripping/plating at 0.1 mA/cm² current density for 30 minutes per half cycle at 30° C. FIG. 4e is a graph showing cycling performance of Li|PAATFSI EC/PC60|LFP full cell at 0.1 C and 0.2 C at room temperature around 20° C.

FIGS. 5a-5c. FIG. 5a provides a schematic synthesis of Tetra-TFSILi. FIG. 5b is a graph showing the ionic conductivity as a function of temperature of LiTFSI and Tetra-TFSILi in carbonate-based electrolyte. FIG. 5c is a graph showing the ionic conductivity as a function of temperature of Tetra-TFSILi in a crosslinked polyethylene oxide membrane dry and plasticized with 50 wt % succinonitrile.

FIGS. 6a-6b. FIG. 6a provides a schematic synthesis of PEI-TFSILi. FIG. 6b is a graph showing the ionic conductivity as a function of temperature of dry PEI-TFSILi and PEI-TFSILi lighly crosslinked with PEO 2000.

### DETAILED DESCRIPTION

As used herein, the term “hydrocarbon group” (also denoted by the group R) is defined as a chemical group composed of at least carbon and hydrogen. The term “group” indicates the absence of a hydrogen atom in order for the group to form a single covalent bond. The group may also be considered a mono-radical. In some embodiments, the hydrocarbon group is composed solely of carbon and hydrogen. In other embodiments, the hydrocarbon group may (i.e., optionally) be substituted with one or more fluorine atoms to result in partial or complete fluorination of the hydrocarbon group. In other embodiments, as further discussed below, the hydrocarbon group may contain one or more other heteroatoms (e.g., O, N, S, B, or Si) or heteroatom-containing groups. The term “hydrocarbon linker,” as also used herein, corresponds to a diradical that can be derived from any of the hydrocarbon groups described herein by removing an additional hydrogen atom from the hydrocarbon group. For example, a methylene (—CH₂—) linker can be derived from a methane (—CH₃) group by removal of an additional hydrogen atom from the methyl group.

The hydrocarbon group (R) or linker may contain at least or greater than 1, 2, 3, 4, 5, or 6 carbon atoms and up to any number of carbon atoms, such as 10, 20, 30, 40, 50, 60, 70, 80, 90, or 100 carbon atoms. In some embodiments, R or a linker thereof may be polymeric and may thus contain more than 100 carbon atoms. In some embodiments, R or a linker thereof contains 1-50 carbon atoms. In different embodiments, one or more of the hydrocarbon groups may contain, for example, 1, 2, 3, 4, 5, 6, 7, 8, 9, 10, 12, 15, 18, 20, 22, 24, 26, 28, 30, 40, or 50 carbon atoms, or a number of carbon atoms within a particular range bounded by any two of the foregoing carbon numbers (e.g., 1-50, 2-50, 3-50, 4-50, 5-50, 6-50, 1-40, 2-40, 3-40, 4-40, 5-40, 6-40, 1-30, 2-30, 3-30, 4-30, 5-30, 6-30, 1-20, 2-20, 3-20, 4-20, 5-20, 6-20, 1-12, 2-12, 3-12, 4-12, 5-12, or 6-12 carbon atoms). Hydrocarbon groups or linkers in different compounds described herein, or in different positions of a compound, may possess the same or different number (or preferred range thereof) of carbon atoms in order to independently adjust or optimize properties of the compound.

In a first set of embodiments, the hydrocarbon group (R) is a saturated and straight-chained group, i.e., a straight-chained (linear)alkyl group. Some examples of straight-chained alkyl groups include methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-eicosyl, n-docosyl, n-tetracosyl, n-hexacosyl, n-octacosyl, and n-triacontyl groups, as well as those containing 40, 50, or more carbon atoms. Examples of corresponding linkers can be derived from any of the foregoing groups by removal of an additional hydrogen atom to form a diradical (e.g., methyl converts to methylene, and ethyl converts to ethylene).

In a second set of embodiments, the hydrocarbon group (R) is saturated and branched, i.e., a branched alkyl group. Some examples of branched alkyl groups include isopropyl(2-propyl), isobutyl(2-methylprop-1-yl), sec-butyl(2-butyl), t-butyl(1,1-dimethylethyl-1-yl), 2-pentyl, 3-pentyl, 2-methylbut-1-yl, isopentyl(3-methylbut-1-yl), 1,2-dimethylprop-1-yl, 1,1-dimethylprop-1-yl, neopentyl(2,2-dimethylprop-1-yl), 2-hexyl, 3-hexyl, 2-methylpent-1-yl, 3-methylpent-1-yl, isohexyl(4-methylpent-1-yl), 1,1-dimethylbut-1-yl, 1,2-dimethylbut-1-yl, 2,2-dimethylbut-1-yl, 2,3-dimethylbut-1-yl, 3,3-dimethylbut-1-yl, 1,1,2-trimethylprop-1-yl, 1,2,2-trimethylprop-1-yl, isoheptyl, isooctyl, and the numerous other branched alkyl groups having up to 20, 30, 40, 50, or more carbon atoms, wherein the “1-yl” suffix represents the point of attachment of the group. Examples of corresponding linkers can be derived from any of the foregoing groups by removal of an additional hydrogen atom to form a diradical.

In a third set of embodiments, the hydrocarbon group (R) is saturated and cyclic, i.e., a cycloalkyl group. Some examples of cycloalkyl groups include cyclopropyl, cyclobutyl, cyclopentyl, cyclohexyl, cycloheptyl, and cyclooctyl groups. The cycloalkyl group can also be a polycyclic (e.g., bicyclic) group by either possessing a bond between two ring groups (e.g., dicyclohexyl) or a shared (i.e., fused) side (e.g., decalin and norbornane). Examples of corresponding linkers can be derived from any of the foregoing groups by removal of an additional hydrogen atom to form a diradical.

In a fourth set of embodiments, the hydrocarbon group (R) is unsaturated and straight-chained, i.e., a straight-chained (linear) olefinic or alkenyl group. The unsaturation occurs by the presence of one or more carbon-carbon double bonds and/or one or more carbon-carbon triple bonds. Some examples of straight-chained olefinic groups include vinyl, propen-1-yl(allyl), 3-buten-1-yl(CH₂—CH—CH₂—CH₂—), 2-buten-1-yl(CH₂—CH═CH—CH₂—), butadienyl, 4-penten-1-yl, 3-penten-1-yl, 2-penten-1-yl, 2,4-pentadien-1-yl, 5-hexen-1-yl, 4-hexen-1-yl, 3-hexen-1-yl, 3,5-hexadien-1-yl, 1,3,5-hexatrien-1-yl, 6-hepten-1-yl, ethynyl, propargyl(2-propynyl), 3-butynyl, and the numerous other straight-chained alkenyl or alkynyl groups having up to 20, 30, 40, 50, or more carbon atoms. Examples of corresponding linkers can be derived from any of the foregoing groups by removal of an additional hydrogen atom to form a diradical.

In a fifth set of embodiments, the hydrocarbon group (R) is unsaturated and branched, i.e., a branched olefinic or alkenyl group. Some examples of branched olefinic groups include propen-2-yl(CH₂═C·—CH₃), 1-buten-2-yl(CH₂═C·—CH₂—CH₃), 1-buten-3-yl(CH₂—CH—CH·—CH₃), 1-propen-2-methyl-3-yl(CH₂═C(CH₃)—CH₂—), 1-penten-4-yl, 1-penten-3-yl, 1-penten-2-yl, 2-penten-2-yl, 2-penten-3-yl, 2-penten-4-yl, and 1,4-pentadien-3-yl, and the numerous other branched alkenyl groups having up to 20, 30, 40, 50, or more carbon atoms, wherein the dot in any of the foregoing groups indicates a point of attachment. Examples of corresponding linkers can be derived from any of the foregoing groups by removal of an additional hydrogen atom to form a diradical.

In a sixth set of embodiments, the hydrocarbon group (R) is unsaturated and cyclic, i.e., a cycloalkenyl group. The unsaturated cyclic group may be aromatic or aliphatic. Some examples of unsaturated cyclic hydrocarbon groups include cyclopropenyl, cyclobutenyl, cyclopentenyl, cyclopentadienyl, cyclohexenyl, cyclohexadienyl, phenyl, benzyl, cycloheptenyl, cycloheptadienyl, cyclooctenyl, cyclooctadienyl, and cyclooctatetraenyl groups. The unsaturated cyclic hydrocarbon group may or may not also be a polycyclic group (such as a bicyclic or tricyclic polyaromatic group) by either possessing a bond between two of the ring groups (e.g., biphenyl) or a shared (i.e., fused) side, as in naphthalene, anthracene, phenanthrene, phenalene, or indene fused ring systems. Examples of corresponding linkers can be derived from any of the foregoing groups by removal of an additional hydrogen atom to form a diradical (e.g., phenyl converts to phenylene).

As indicated earlier above, any of the hydrocarbon groups described above may be substituted with one or more fluorine atoms. As an example, an n-octyl group may be substituted with a single fluorine atom to result in, for example, a 7-fluorooctyl or 8-fluorooctyl group, or substituted with two or more fluorine atoms to result in, for example, 7,8-difluorooctyl, 8,8-difluorooctyl, 8,8,8-trifluorooctyl, or perfluorooctyl group. Any of the hydrocarbon groups described herein may contain a single ether (—O—) or thioether (—S—) linkage connecting between carbon atoms in the hydrocarbon group. An example of a hydrocarbon group containing a single ether or thioether group is —(CH₂)₂—X—(CH₂)₇CH₃, wherein X represents O or S.

As further indicated earlier above, any of the hydrocarbon groups described above may be substituted with one or more heteroatom-containing groups. Some examples of heteroatom-containing groups include —OH, —OR″, —NH₂, —NHR″, —NR″₂, —NO₂, —SR″, —SO₂R″, —SO₂NR″₂, —C(O)R″, —C(O)OR″, —C(O)NH₂, —C(O)NHR″, —C(O)NR″₂, —C(S)OR″, —C(O)SR″, —C(S)NH₂, —C(S)NHR″, and —C(S)NR″₂ groups, wherein R″ groups are independently selected from alkyl groups containing 1-20 carbon atoms. In some embodiments, any one or more heteroatom-containing groups are excluded from the hydrocarbon groups. In some embodiments, the hydrocarbon group(s) is/are composed of carbon and hydrogen with the exception that they may (i.e., optionally) include one or more ether (—O—) groups, or more particularly, one or more ethyleneoxy (—CH₂CH₂O—) groups.

In one aspect, the present disclosure is directed to TFSI-based electrolyte compounds (i.e., “electrolyte compounds”) having high lithium-ion conductivity (e.g., at least or above 1.0×10⁻⁹ S/cm at 80° C.); high cation transport number (e.g., at least or above 0.85), and low melting point or glass transition temperature (T_{g}), e.g., below 100° C. In one set of embodiments, the electrolyte compounds are small discrete molecules typically having a molecular weight of up to or less than 5,000 g/mol, or more typically, up to or less than 4,000 g/mol, 3,000 g/mol, 2,000 g/mol, or 1,000 g/mol. In another set of embodiments, the electrolyte compounds are polymeric molecules, which typically have a variation in lengths, and thus an average molecular weight, typically at least or above 5,000 g/mol or 10,000 g/mol.

The electrolyte compounds described herein are within the scope of the following generic formula:

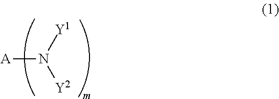

The variable A in Formula (1) is a linear, branched, or cyclic hydrocarbon group (R), such as any of those described above, containing at least one carbon atom and optionally containing one or more heteroatoms selected from N, O, and S. In some embodiments, A is a hydrocarbon group (R) that contains no heteroatoms. In some embodiments, A excludes Si atoms, in which case A does not have or include a siloxane structure, portion, or group. In other embodiments, A is a hydrocarbon group (R) that contains precisely or at least one O atom, or precisely or at least one N atom, or at least one S atom. In some embodiments, A is a hydrocarbon group (R) that contains precisely or at least two, three, four, five, or six N atoms. The hydrocarbon group R (i.e., variable A) in Formula (1) can have any of the carbon numbers provided above (e.g., at least or greater than 1, 2, 3, 4, 5, 6, 7, 8, 9, 10, 12, 15, 18, 20, 22, 24, 26, 28, 30, 40, 50, or 100 carbon atoms or a number of carbon atoms within a range bounded by any two of the foregoing values) and can be any of the types of hydrocarbons described above (e.g., linear, branched, or cyclic alkyl group with or without the presence of one or more heteroatoms).

In some embodiments, the hydrocarbon group R (i.e., variable A) of Formula (1) is or includes a linear or branched alkyl group containing any number of carbon atoms provided above, with or without the presence of one or more heteroatoms. In more particular embodiments, the hydrocarbon group R (i.e., variable A) of Formula (1) is or includes a linear or branched alkyl group containing any number of carbon atoms provided above, or more particularly, containing at least 10, 20, 30, 40, 50 or more carbon atoms, and containing at least or greater than one, two, three, or four nitrogen atoms. In some embodiments, the variable A contains one or more (or a multiplicity of, e.g., at least or greater than 3, 4, 5, or 6) linkages of the formula —CH₂CH₂NH— (as typically found in polyethyleneimine, i.e., PEI) and/or pendant groups of the formula —CH₂)rNH₂ (as typically found in polyallylamine) wherein r is an integer of 1, 2, 3, 4, 5, or 6 or a value within a range bounded by any of two of these values. In separate or further embodiments, the variable A may contain one or more (or a multiplicity of, e.g., at least or greater than 3, 4, 5, or 6) ether or thioether linkages of the formula —O— or —S—, respectively, and/or OH or SH groups. The variable A may or may not include other types of heteroatom-containing linkages, such as amide (—C(O) NH—), ester (—C(O)O—), urea (—NHC(O) NH—), carbonate (—OC(O)O—), and diazo (—N—N—) linkages. The variable A may or may not include carboxylic acid (C(O)OH) and carboxy ester (C(O)OR) groups.

In some embodiments, the hydrocarbon group R (i.e., variable A) of Formula (1) is a polymeric hydrocarbon group, which may or may not contain heteroatoms selected from N, O, and S. In some embodiments, the polymer does not contain Si and thus excludes Si-containing polymers such as the polysiloxanes. When A is a polymeric group, m is typically at least 10 or higher (e.g., at least 20, 50, 100, 200, or 500). In more particular embodiments, A has a linear or branched polymeric structure that includes a multiplicity of N atoms, typically within repeating units of the polymer. Such polymers are herein referred to as nitrogen-containing polymers. The nitrogen-containing polymer may or may not further contain O and/or S heteroatoms (or more particularly, OH and/or ether groups, such as may be produced by the reaction between amine groups of the polymer and epoxy groups of a crosslinker, wherein the crosslinker may further contain an ethylene glycol or PEG linkage). Some examples of types of polymeric moieties for A include poly(allylamine), polyethyleneimine (PEI), poly(vinylamine), polylysine, poly(4-aminostyrene), and PAMAM dendrimers (e.g., first, second, or third generation). Notably, Y¹ and Y² may be located on any of the nitrogen atoms of the polymer to form —NY¹Y² units of Formula (1), with the variable A representing the remainder of the polymer not containing the —NY¹Y² units, wherein at least one of Y¹ and Y² is a sulfonylimide moiety of Formula (1-1). Typically, due to steric hindrance, at least some of the nitrogen atoms of the polymer are not attached to sulfonylimide moieties and may be in the form of, for example, primary amino groups (—NH₂), and/or secondary amino linkages (—NH—), and/or tertiary amino linkages (—N—) in the polymer.

The variables Y¹ and Y² in Formula (1) are independently selected from H atom and a sulfonylimide group of the formula

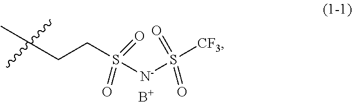

wherein B⁺ is H⁺ or an alkali metal ion, such as Li⁺, Na⁺, K⁺, Rb⁺, or Cs⁺. Moreover, at least one of Y¹ and Y² is a sulfonylimide group of the above formula (1-1). In some embodiments, one of Y¹ and Y² is a sulfonylimide group (and the other of Y¹ and Y² is H). In other embodiments, both of Y¹ and Y² are sulfonylimide groups.

The variable m in Formula (1) is an integer of at least 1. In some embodiments, m is 1, in which case only a single instance of —NY¹Y² is present. When m is 2, two instances of —NY¹Y² are present, and so on. Notably, Y¹ and Y² can be selected differently for different instances of m, i.e., when m is greater than 1. For example, in the case of m=2, one instance of —NY¹Y² may select both of Y¹ and Y² as the sulfonylimide of Formula (1-1) while the second instance of —NY¹Y² may select only one of Y¹ and Y² as the sulfonylimide (with the other of Y¹ and Y² being H). Typically, due to steric constraints, the maximum possible number of m for a given A moiety is the number of carbon atoms in the A moiety. More typically, m is lower than the number of carbon atoms in the A moiety, and more typically 50% or less than the number of carbon atoms in the A moiety. Depending on the size of A (i.e., the number of carbon atoms in A), the variable m may be precisely, at least, or greater than, for example, 2, 3, 4, 5, 6, 7, 8, 9, 10, 12, 15, or 20. In the case of A being polymeric, the value of m may exceed 20, e.g., at least or greater than 30, 40, 50, 100, 200, or 500.

In other particular embodiments of Formula (1), m is 1 and the linear, branched, or cyclic hydrocarbon group in variable A has the formula R′O(CH₂)ₚ— wherein R′ is H or a hydrocarbon (R) containing 1-12 carbon atoms and optionally containing one or more O atoms, and p is an integer of 1-12, which results in the electrolyte compound having the following formula:

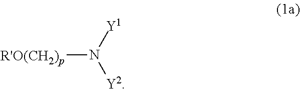

In some embodiments of Formula (1a), R′ is H. In other embodiments of Formula (1a), R′ is selected from methyl, ethyl, n-propyl, isopropyl, n-butyl, sec-butyl, isobutyl, and t-butyl groups. In the methylene (—CH₂—) linkage in Formula (1a), a hydrogen atom may be replaced with a methyl group to form a —CH(CH₃)— linkage (which may be independently done over the p iterations of the methylene linker). In other embodiments of Formula (1a), R′ is a hydrocarbon group that contains at least one O atom. When R′ contains at least one O atom, R′ may be, for example, H(OCH₂CH₂)ₜ— or H(OCH₂(CH₃)CH₂)ₜ—, wherein t may be an integer of precisely or at least 1, 2, 3, 4, 5, 6, 7, 8, 9, 10, 11, or 12 or an integer within a range bounded by any two of the foregoing values. Y¹ and Y² are selected from H and sulfonylimide of Formula (1-1), as provided earlier above.

In other particular embodiments of Formula (1), the electrolyte compound has the following formula:

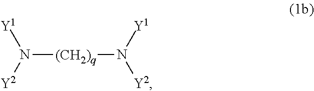

wherein q is an integer of 1-12. In different embodiments, q is an integer of 1, 2,3, 4, 5, 6, 7, 8, 9, 10, 11, or 12, or an integer within a range bounded by any two of the foregoing values, e.g., 1-12, 2-12, 3-12, 1-6, 2-6, 3-6, 1-3, or 2-4. Y¹ and Y² are as defined above, i.e., independently selected from H atom and a sulfonylimide group of the formula (1-1), provided that at least one of Y¹ and Y² is a sulfonylimide group. In some embodiments, both Y¹ and Y² are sulfonylimide groups.

The TFSI-containing compositions described above can be synthesized by methods well known in the art. For example, in some embodiments, these compositions are synthesized by reacting an amine-containing molecule that contains primary and/or secondary amine groups with a vinyl-TFSI (i.e., VTFSI) molecule of the formula [CH₂═CH—S(O)₂—N⁻—S(O)₂—CF₃][B⁺], wherein B⁺ is an ion as described earlier above, under conditions conducive to reaction between the amine and vinyl groups via a Michael addition reaction. The amine-containing molecule can be any of those described above under the discussion of A, including those with one, two, three, or four amine groups and those with a much greater number (e.g., at least 5, 10, 15, or 20) of amine groups as would be present in a polymeric amine-containing molecule. The VTFSI reactant molecule can be either commercially obtained or prepared by means known in the art.

In another aspect, the present disclosure is directed to an electrolyte solution containing any of the electrolyte (i.e., TFSI-containing) compositions described above dissolved in or plasticized with a solvent. For purposes of the present disclosure, the solvent (which may alternatively function as a plasticizer) should be suitable for incorporation into a battery, particularly a lithium-ion battery. The solvent is typically a polar solvent, more typically aprotic, and may be non-ionic or an ionic liquid. The solvent can be any such solvent known to be useful in and compatible with a battery. The solvent typically has a melting point of up to or less than 100, 90, 80, 70, 60, or 50° C., and more typically, below room temperature, i.e., below about 25° C., and more typically, up to or less than 20, 15, 10, 5, or 0° C. The solvent may be, for example, a carbonate, sulfone, siloxane, silane, ether, ester, nitrile, sulfoxide, amide solvent, organochloride solvent, ketone solvent, phosphate ester solvent, phosphonate ester solvent, or a mixture thereof. The solvent may be present in the electrolyte solution in any suitable concentration, such as a concentration of at precisely, about, or at least, 10, 20, 30, 40, 50, 60, 70, 80, 90, 100, 120, 150, 180, or 200 wt % (i.e., by weight of solvent to electrolyte compound), or the solvent may be present in a concentration within a range bounded by any two of the foregoing values, e.g., 10-200 wt %, 20-200 wt %, 50-200 wt %, 80-200 wt %, 100-200 wt %, 120-200 wt %, 150-200 wt %, 180-200 wt %, 10-180 wt %, 20-180 wt %, 50-180 wt %, 80-180 wt %, 100-180 wt %, 120-180 wt %, 150-180 wt %, 10-150 wt %, 20-150 wt %, 50-150 wt %, 80-150 wt %, 100-150 wt %, 120-150 wt %, 10-120 wt %, 20-120 wt %, 50-120 wt %, 80-120 wt %, 100-120 wt %, 10-100 wt %, 20-100 wt %, 50-100 wt %, or 80-100 wt %.

In a first set of embodiments, the solvent is or includes a carbonate solvent, which may be cyclic or acyclic. Some examples of cyclic carbonate solvents include ethylene carbonate (EC), propylene carbonate (PC), butylene carbonate (BC), and chloroethylene carbonate. Some examples of acyclic (dialkyl) carbonate solvents include dimethyl carbonate (DMC), diethyl carbonate (DEC), dipropyl carbonate (DPC), ethyl methyl carbonate (EMC), methyl propyl carbonate (MPC), and ethyl propyl carbonate (EPC). The carbonate solvent may or may not also be fluorinated or chlorinated. Some examples of fluorinated carbonate solvents include fluoroethylene carbonate, fluoropropylene carbonate, and trifluoromethyl propylene carbonate.

In a second set of embodiments, the solvent is or includes a sulfone solvent. Some examples of sulfone solvents include methyl sulfone, ethyl methyl sulfone, methyl phenyl sulfone, methyl isopropyl sulfone (MiPS), propyl sulfone, butyl sulfone, tetramethylene sulfone (sulfolane), phenyl vinyl sulfone, allyl methyl sulfone, methyl vinyl sulfone, divinyl sulfone (vinyl sulfone), diphenyl sulfone (phenyl sulfone), dibenzyl sulfone (benzyl sulfone), vinylene sulfone, butadiene sulfone, 4-methoxyphenyl methyl sulfone, 4-chlorophenyl methyl sulfone, 2-chlorophenyl methyl sulfone, 3,4-dichlorophenyl methyl sulfone, 4-(methylsulfonyl) toluene, 2-(methylsulfonyl) ethanol, 4-bromophenyl methyl sulfone, 2-bromophenyl methyl sulfone, 4-fluorophenyl methyl sulfone, 2-fluorophenyl methyl sulfone, 4-aminophenyl methyl sulfone, a sultone (e.g., 1,3-propanesultone), and sulfone solvents containing ether groups (e.g., 2-methoxyethyl(methyl) sulfone and 2-methoxyethoxyethyl(ethyl) sulfone).

In a third set of embodiments, the solvent is or includes a silicon-containing solvent, e.g., a siloxane or silane solvent. Some examples of siloxane solvents include hexamethyldisiloxane (HMDS), 1,3-divinyltetramethyldisiloxane, octamethyltrisiloxane, hexaethyldisiloxane, the polysiloxanes, and polysiloxane-polyoxyalkylene derivatives. Some examples of silane solvents include methoxytrimethylsilane, ethoxytrimethylsilane, dimethoxydimethylsilane, methyltrimethoxysilane, and 2-(ethoxy) ethoxytrimethylsilane. In some embodiments, the siloxane solvent may be fluorinated (e.g., poly(3,3,3-trifluoropropylmethylsiloxane, nonafluorohexylmethylsiloxane, or tridecafluorooctylmethylsiloxane, typically as copolymers with dimethylsiloxane units), or may contain phenyl groups (e.g., phenylmethylsiloxane-dimethylsiloxane copolymer).

In a fourth set of embodiments, the solvent is or includes an ether (glyme) solvent, which may be an acyclic or cyclic ether solvent. Some examples of acyclic ether solvents include diethyl ether, 1,2-dimethoxyethane, 1,2-diethoxyethane, diglyme (bis(2-methoxyethyl) ether), triglyme (triethylene glycol dimethyl ether), tetraglyme (tetraethylene glycol dimethyl ether), ethylene glycol monomethyl ether, ethylene glycol dimethyl ether, ethylene glycol diethyl ether, ethylene glycol monophenyl ether, ethylene glycol diphenyl ether, propylene glycol monomethyl ether, propylene glycol dimethyl ether, diethylene glycol monomethyl ether, triethylene glycol monomethyl ether, tetraethylene glycol monomethyl ether, dipropylene glycol methyl ether, dipropylene glycol dimethyl ether, pentaethylene glycol dimethyl ether, hexaethylene glycol dimethyl ether, 2-ethoxyethyl acetate, propylene glycol methyl ether acetate (PGMEA), and diphenyl ether. Some examples of cyclic ether solvents include 1,3-dioxolane, tetrahydrofuran, 2-methyltetrahydrofuran, tetrahydropyran, 1,4-dioxane, 12-crown-4, and 15-crown-5. The acyclic or cyclic ether solvent may or may not also be fluorinated. The fluorinated ether solvent may be, for example, a mono-, di-, tri-, tetra-, penta-, hexa- or per-fluoro derivative of any of the foregoing ether solvents. Some examples of fluorinated acyclic ether solvents include 1,1,2,2-tetrafluoroethyl-2,2,3,3-tetrafluoropropyl ether, bis(2,2,2-trifluoroethyl) ether, perfluoro-1,2-dimethoxyethane, and perfluorodiglyme.

In a fifth set of embodiments, the solvent is or includes an ester (carboxylate) solvent, which may be an acyclic or cyclic ester solvent. Some examples of acyclic ester solvents include methyl acetate (MA), ethyl acetate (EA), n-propyl acetate, isopropyl acetate, methyl formate (MF), ethyl formate (EF), n-propyl formate (PF), n-butyl formate, t-butyl formate, methyl propionate (MP), ethyl propionate (EP), propyl propionate, methyl butyrate (MB), and ethyl butyrate (EB). Some examples of cyclic ester solvents (i.e., lactone solvents) include γ-butyrolactone, α-methyl-γ-butyrolactone, β-butyrolactone, β-propiolactone, γ-valerolactone, δ-valerolactone, α-bromo-γ-butyrolactone, γ-phenyl-γ-butyrolactone, ε-caprolactone, γ-caprolactone, δ-caprolactone, γ-octanolactone, γ-nanolactone, γ-decanolactone, and δ-decanolactone. The acyclic or cyclic ester solvent may or may not also be fluorinated. The fluorinated ester solvent may be, for example, a mono-, di-, tri-, tetra-, penta-, hexa- or per-fluoro derivative of any of the foregoing ester solvents. Some examples of fluorinated acyclic ester solvents include trifluoromethyl acetate, 2,2,2-trifluoroethyl acetate, 2,2,2-trifluoroethyl butyrate, trifluoromethyl formate, and trifluoroethyl formate. An example of a fluorinated cyclic ester solvent is a-fluoro-8-caprolactone.

In various other embodiments, the solvent may be or include a nitrile solvent, amide solvent, organochloride solvent, ketone solvent, sulfoxide solvent, phosphate ester solvent, or phosphonate ester solvent. Some examples of nitrile solvents include acetonitrile, propionitrile, and butyronitrile. Some examples of amide solvents include formamide, N,N-dimethylformamide, N,N-diethylformamide, acetamide, dimethylacetamide, diethylacetamide, gamma-butyrolactam, and N-methylpyrrolidone (NMP). Some examples of organochloride solvents include methylene chloride, chloroform, 1,1,1-trichloroethane, trichloroethylene, and perchloroethylene. Some examples of ketone solvents include acetone and 2-butanone. An example of a sulfoxide solvent is dimethyl sulfoxide. Some examples of phosphate ester solvents include trimethyl phosphate, triethyl phosphate, tripropyl phosphate, and tributyl phosphate. An example of a phosphonate ester solvent is dimethyl methylphosphonate. The solvent may also be, for example, hexamethylphosphoramide (HMPA) or 1,3-dimethyl-3,4,5,6-tetrahydro-2 (1H)-pyrimidinone (DMPU).

In some embodiments, any one or more classes or specific types of solvents are excluded from the electrolyte solution. In other embodiments, a combination of two or more solvents, selected from any of the above solvents, are included in the electrolyte solution, provided that the solvents in the mixture are miscible and compatible.

A solvent additive may or may not also be included in the electrolyte. If present, the solvent additive should typically facilitate formation of a solid electrolyte interphase (SEI) on the anode. The solvent additive can be, for example, a solvent that possesses one or more unsaturated groups containing a carbon-carbon double bond and/or one or more halogen atoms. Some particular examples of solvent additives include vinylene carbonate (VC), vinyl ethylene carbonate, allyl ethyl carbonate, vinyl acetate, divinyl adipate, acrylic acid nitrile, 2-vinyl pyridine, maleic anhydride, methyl cinnamate, ethylene carbonate, halogenated ethylene carbonate, bromobutyrolactone, methyl chloroformate, and sulfite additives, such as ethylene sulfite(ES), propylene sulfite (PS), and vinyl ethylene sulfite (VES). In other embodiments, the additive is selected from 1,3-propanesultone, ethylene sulfite, propylene sulfite, fluoroethylene sulfite (FEC), a-bromo-γ-butyrolactone, methyl chloroformate, t-butylene carbonate, 12-crown-4 ether, carbon dioxide (CO₂), sulfur dioxide (SO₂), sulfur trioxide (SO₃), acid anhydrides, reaction products of carbon disulfide and lithium, and polysulfide. The additive is generally included in an amount that effectively impacts SEI formation without reducing the electrochemical window by an appreciable extent, typically below about 5.0 V. The additive may be included in an amount of, for example, 0.1, 0.5, 1, 2, 3, 4, 5, or 10 wt % by weight of the electrolyte solution, or an amount within a range bounded by any two of the foregoing exemplary values. In some embodiments, any one or more of the above disclosed additives is excluded. Any of the foregoing additives may, in some embodiments, serve as the solvent itself.

The electrolyte solution may, in some embodiments, include a metal salt. The metal ion in the metal salt may be, for example, one or more of lithium, sodium, potassium, magnesium, calcium, zinc, and aluminum. The counteranion of the metal salt may be essentially any anion, provided that the resulting salt is fully soluble in the solvent. The anion may be inorganic or organic. Some examples of inorganic counteranions include the halides (e.g., chloride, bromide, or iodide), hexafluorophosphate (PF₆⁻), hexachlorophosphate (PCl₆⁻), perchlorate, chlorate, chlorite, perbromate, bromate, bromite, iodate, aluminum fluorides (e.g., AlF₄⁻), aluminum chlorides (e.g., Al₂Cl₇⁻ and AlCl₄⁻), aluminum bromides (e.g., AlBr₄⁻), nitrate, nitrite, sulfate, sulfite, phosphate, phosphite, arsenate, hexafluoroarsenate (AsF₆⁻), antimonate, hexafluoroantimonate (SbF₆⁻), selenate, tellurate, tungstate, molybdate, chromate, silicate, the borates (e.g., borate, diborate, triborate, tetraborate), tetrafluoroborate, anionic borane clusters (e.g., B₁₀H₁₀²⁻ and B₁₂H₁₂²⁻), perrhenate, permanganate, ruthenate, perruthenate, and the polyoxometallates. Some examples of organic counteranions include the bis(perfluoroalkylsulfonyl)imides (e.g., (CF₃SO₂)₂N⁻), fluorosulfonates (e.g., CF₃SO₃⁻, CF₃CF₂SO₃⁻, CF₃ (CF₂)₂SO₃⁻, CHF₂CF₂SO₃⁻, and the like), carboxylates (e.g., formate, acetate, propionate, butyrate, valerate, lactate, pyruvate, oxalate, malonate, glutarate, adipate, decanoate, and the like), sulfonates (e.g., CH₃SO₃, CH₃CH₂SO₃, CH₃ (CH₂) 2SO₃″, benzenesulfonate, toluenesulfonate, dodecylbenzenesulfonate, and the like), organoborates (e.g., BR₁R₂R₃R₄, wherein R₁, R₂, R₃, R₄ are typically hydrocarbon groups containing 1 to 6 carbon atoms), dicyanamide (i.e., N(CN)₂⁻), tricyanomethanide (i.e., C(CN)₃) and the phosphinates (e.g., bis-(2,4,4-trimethylpentyl)-phosphinate). In some embodiments, any one or more classes or specific types of counteranions, as provided above, are excluded from the electrolyte solution. In some embodiments, a metal salt is excluded from the electrolyte solution.

The metal salt is present in the electrolyte solution in any suitable concentration, such as a molar concentration of at least 0.05 M and up to 1.5 M. In different embodiments, the metal salt is present in the solvent in a molar concentration of 0.05 M, 0.1 M, 0.25 M, 0.3 M, 0.4 M, 0.5 M, 0.6 M, 0.7 M, 0.8 M, 0.9 M, 1 M, 1.1 M, 1.2 M, 1.3 M, 1.4 M, or 1.5 M, or a molar concentration within a range bounded by any two of the foregoing concentrations (e.g., 0.05-1.5 M, 0.1-1.5 M, 0.25-1.5 M, 0.5-1.5 M, 0.05-1.25 M, 0.1-1.25 M, 0.25-1.25 M, 0.5-1.25 M, 0.05-1 M, 0.1-1 M, 0.25-1 M, or 0.5-1 M).

The electrolyte solution may also be impregnated into a scaffold to form a composite. The scaffold may be, for example, a glass fiber mesh, carbon mesh or a porous polymeric scaffold consisting of (for example) polycarbonate, polysulfone, polypropylene, polyethylene, polyvinylidene fluoride or polytetrafluoroethylene. The resulting composite can be used as a solid or gel electrolyte in a battery.

In another aspect, the present disclosure is directed to a lithium-based battery containing the above described electrolyte solution in contact with an anode and cathode of the battery, wherein the electrolyte solution contains an electrolyte compound dissolved in or plasticized with a solvent. In some embodiments, the electrolyte solution is embedded within a scaffold to form a composite, as described above. The lithium-based battery may be a lithium metal (plate) battery, in which the anode contains a film of lithium metal, or a lithium-ion battery, in which the anode contains lithium ions stored in a base material (e.g., graphite). Whether the battery contains a lithium anode or lithium-ion anode, the battery may be a single-use (primary) or rechargeable (secondary) battery.

In embodiments where the above described electrolyte composition is in contact with an anode and cathode of the lithium-based battery but not incorporated into the cathode, the positive (cathode) electrode can have any of the compositions well known in the art, for example, a lithium metal oxide, wherein the metal is typically a transition metal, such as Co, Fe, Ni, or Mn, or combination thereof, or manganese dioxide (MnO₂), iron disulfide (FeS₂), or copper oxide (CuO). In some embodiments, the cathode has a composition containing lithium, nickel, and oxide. In further embodiments, the cathode has a composition containing lithium, nickel, manganese, and oxide, or the cathode has a composition containing lithium, nickel, cobalt, and oxide. Some examples of cathode materials include LiCoO₂, LiMn₂O₄, LiNiCoO₂, LiMnO₂, LiFePO₄, LiNiCoAlO₂, and LiNiₓMn₂₋ₓO₄ compositions, such as LiNi_{0.5}Mn_{1.5}O₄, the latter of which are particularly suitable as 5.0 V cathode materials, wherein x is a number greater than 0 and less than 2. In some embodiments, one or more additional elements may substitute a portion of the Ni or Mn. In some embodiments, one or more additional elements may substitute a portion of the Ni or Mn, as in LiNiₓCo₁₋ₓPO₄, and LiCuₓMn₂₋ₓO₄, materials (Cresce, A. V., et al., Journal of the Electrochemical Society, 2011, 158, A337-A342). In further specific embodiments, the cathode has a composition containing lithium, nickel, manganese, cobalt, and oxide, such as LiNiMnCoO₂ or a LiNi_{w-y-z}MnyCO_{z}O₂ composition (wherein w+y+z=1), e.g., LiNi_{0.8}Mn_{0.1}Co_{0.1}O₂. The cathode may alternatively have a layered-spinel integrated Li[Ni_{1/3}Mn_{2/3}]O₂ composition, as described in, for example, Nayak et al., Chem. Mater., 2015, 27 (7), pp. 2600-2611. To improve conductivity at the cathode, conductive carbon material (e.g., carbon black, carbon fiber, or graphite) may be admixed with the positive electrode material. In some embodiments, any one or more of the above types of positive electrodes may be excluded from the battery.

In the lithium-based battery, the negative (anode) electrode may be lithium metal or a material in which lithium ions are contained and can flow. For lithium-ion batteries, the anode may be any of the carbon-containing and/or silicon-containing anode materials well known in the art of lithium-ion batteries. In some embodiments, the anode is a carbon-based composition in which lithium ions can intercalate or embed, such as elemental carbon, such as graphite (e.g., natural or artificial graphite), petroleum coke, carbon fiber (e.g., mesocarbon fibers), carbon (e.g., mesocarbon) microbeads, fullerenes (e.g., carbon nanotubes, i.e., CNTs), and graphene. The carbon-based anode is typically at least 70 80, 90, or 95 wt % elemental carbon. The silicon-containing composition, which may be used in the absence or presence of a carbon-containing composition in the anode, can be any of the silicon-containing compositions known in the art for use in lithium-ion batteries. Lithium-ion batteries containing a silicon-containing anode may alternatively be referred to as lithium-silicon batteries. The silicon-containing composition may be, for example, in the form of a silicon-carbon (e.g., silicon-graphite, silicon-carbon black, silicon-CNT, or silicon-graphene) composite, silicon microparticles, or silicon nanoparticles, including silicon nanowires. The negative electrode may alternatively be a metal oxide, such as tin dioxide (SnO₂), titanium dioxide (TiO₂), or lithium titanate (e.g., Li₂TiO₃ or Li₄Ti₅O₁₂), or a composite of carbon and a metal oxide. In other embodiments, the anode may be composed partially or completely of a suitable metal or metal alloy (or intermetallic), such as tin, tin-copper alloy, tin-cobalt alloy, or tin-cobalt-carbon intermetallic. In some embodiments, any one or more of the above types of negative electrodes may be excluded from the battery.

In some embodiments, the negative (anode) electrode of the battery may be a carbon-based composition in which alkali or other ions can be stored (e.g., intercalated or embedded), such as elemental carbon, or more particularly graphite (e.g., natural or artificial graphite), petroleum coke, carbon fiber (e.g., mesocarbon fibers), or carbon (e.g., mesocarbon) microbeads. The anode may be at least 70 80, 90, or 95 wt % elemental carbon. The negative electrode may alternatively be a metal oxide, such as tin dioxide (SnO₂) or titanium dioxide (TiO₂), or a composite of carbon and a metal oxide.

The positive and negative electrode compositions may be admixed with an adhesive (e.g., PVDF, PTFE, and co-polymers thereof) in order to be properly molded as electrodes. Typically, positive and negative current collecting substrates (e.g., Cu or Al foil) are also included. The SPE composition is typically incorporated in the form of a film having any of the thicknesses described earlier above. The film of solid electrolyte is typically made to be in contact with at least one (more typically both) of the electrodes. The assembly and manufacture of lithium-based batteries are well known in the art.

Examples have been set forth below for the purpose of illustration and to describe certain specific embodiments of the invention. However, the scope of this invention is not to be in any way limited by the examples set forth herein.

### Examples

### Overview

The most widely utilized TFSI-based monomers for the synthesis of single-ion conducting polymer (SICPs) are methacrylate TFSI (MTFSI) and styrene TFSI (STFSI). While these monomers have the advantage of commercial availability and can be easily polymerized, PolyMTFSI (PMTFSI) and PolySTFSI (PSTFSI) exhibit high glass transition temperatures, which negatively impact their room temperature ionic conductivities

The following work describes a novel polymer electrolyte synthesized by the Micheal addition reaction between poly(allylamine)(PAA) and a vinyl TFSI anion under mild reaction conditions. The resulting PAATFSI polymer generally exhibits a lower glass transition temperature and several orders of magnitude higher Li-ion conductivity than other TFSI-based single-ion conducting homopolymers in the dry state. Moreover, PAATFSI exhibits excellent Li-ion conductivity (2.7×10⁻⁴ S/cm at 30° C.) with the addition of a plasticizer (60 wt % of carbonate solvent), which results in a stable lithium-metal battery performance. This study demonstrates a facile route for the synthesis of novel single-ion conducting polymer (SICP) electrolytes that enhance the performance of lithium-based batteries.

### EXPERIMENTAL

### Materials

Poly(allylamine)(PAA, 60,000 g/mol, 10 wt % in water), poly(ethylene glycol) (PEG, 1000 g/mol), bis(trifluoromethane) sulfonimide lithium salt (LiTFSI, 99.95%), 2-chloroethanesulfonyl chloride (98%), trifluoromethanesulfonamide (TFSA, 98%) ethylene carbonate (EC, ≥99%), and propylene carbonate (PC, 99.7%) were purchased from commercial sources. Solvents were dried over molecular sieves before use.

### Polymer Electrolyte Synthesis

VTFSI K⁺ was synthesized following a modified literature procedure (H. T. Ho et al., Eur Polym J., 2018, 107, 74-81). 2-chloroethanesulfonyl chloride (10 ml, 95.7 mmol) was added to a cold solution of triethylamine (TEA, 258.4 mmol) and TFSA (86.1 mmol) in 50 ml anhydrous acetonitrile under argon. The solution was reacted in an ice bath for 2 hours and then at room temperature for 16 h. The product was filtered, and the acetonitrile was removed from the filtrate by rotary evaporation. The residue was dissolved in 100 ml of dichloromethane and washed with water and 1 M NaCl. The solution was then dried over magnesium sulfate, and the dichloromethane was removed to obtain a brown oily liquid of VTFSI triethylammonium chloride. Conversion to potassium from was achieved by mixing VTFSI triethylammonium chloride in acetonitrile (80 ml) with excess potassium carbonate at room temperature under argon for 24 h. The resulting slurry was filtered, and the acetonitrile removed from the filtrate. The product was washed with cold dichloromethane to yield a white powder (12.5 g).

PAATFSI was synthesized by an aza-Michael addition reaction between the primary amine of poly(allylamine) and the carbon-carbon double bond of VTFSI K⁺. PAA (2 g) and VTFSI K⁺ (11.6 g, 1.2 eq) were added to 45 ml of ethanol and mixed at 75° C. for 72 h. The polymer was purified and exchanged to lithium form by dialysis against deionized water and LiCl. After dialysis, the water was removed by rotary evaporation, and the polymer dried under vacuum at 80° C. for 48 h and stored in an argon-filled glovebox.

The polymer electrolytes were fabricated by mixing appropriate proportions of PAATFSI and plasticizer (PEG or EC/PC 1:1 w/w) and heating at 60° C. under argon for several hours. The mass fraction of plasticizer is denoted as x (e.g., PAATFSI PEGₓ), where x equals 30, 45, or 60 wt % plasticizer. One sample (PAATFSI EC/PC₆₀₊ₛₐₗₜ) was prepared with 0.2 M LiTFSI in EC/PC as the plasticizer.

### Characterizations

Nuclear magnetic resonance spectroscopy (NMR) was conducted using a 400 Hz spectrometer. NMR spectra were collected in dimethylsulfoxide (DMSO-d₆) for VTFSI K⁺ and PAATFSI. The ¹H NMR spectra of PAA was obtained using the as-received polymer solution in D₂O. The glass transition temperature (T_{g}) of the polymer electrolytes was determined using differential scanning calorimetry (DSC). The samples were cycled at a rate of 10° C./min for 2 cycles with T_{g} recorded from the second heating cycle. The thermal decomposition of the polymers was determined by thermal gravimetric analysis (TGA). The samples were heated from 25° C. to 600° C. under nitrogen at a rate of 10° C./min, with the thermal decomposition temperature (Ta) measured at 5% mass loss. Ion concentration was calculated as the moles of Li (1 mol) per repeat unit mass of the polymer to yield the ion exchange capacity as follows: 1 mol/302.19 g*1000=3.31 mmol/g.

The conductivity of the samples was measured by broadband dielectric spectroscopy or electrochemical impedance spectroscopy. All samples were prepared in an argon-filled glovebox. The samples were placed in an airtight sample holder and heated if needed to ensure even distribution of polymer within the battery cell and between the stainless-steel electrodes of the dielectric cell. The PAATFSI and the PEG plasticized samples were measured in a broad temperature range by broadband dielectric spectroscopy covering frequencies between 10⁻² Hz and 10⁶ Hz using a 0.1V voltage. A commercial temperature controller was used to achieve a temperature stabilization of the samples within ±0.2K. The two electrodes of the dielectric capacitor had a diameter of 10.2 mm and were separated by a sapphire disk at a fixed distance of 0.4 mm. The DC conductivities were extracted from the recorded σ′ (v) spectra as the amplitude of the corresponding DC plateaus. The EC/PC plasticized samples were measured by electrochemical impedance spectroscopy. For each measurement, one heat/cool cycle from −20° C. to 80° C. was applied using a temperature-controlled chamber in the frequency range from 7 MHz to 0.1 Hz with a voltage amplitude of 6 mV. Before EIS measurement, the cell was kept at each temperature (−20° C. to 80° C.) for 1 hour. The EIS data during the heating process were further analyzed using commercial EIS data analysis software.

For Li-symmetric and full cell electrochemical characterizations, the polymer electrolyte was dissolved in a small amount of methanol and infused into a 16 mm diameter, 25 μm thickness glass fiber mesh to obtain a final membrane thickness of 50 μm. The polymer was dried at 85° C. under vacuum for 24 h and transferred to an argon-filled glovebox. The membranes were plasticized during cell assembly with appropriate amounts of EC/PC or 0.2 M LiTFSI in EC/PC. Lithium stripping/plating and Li⁺ transport number measurements were carried out in a CR2032 coin cell with the polymer electrolyte sample sandwiched between lithium foil. Stripping/plating evaluations were conducted at 100 μA/cm² with a 30-minute strip/plate cycle at 30° C. Transport number measurements were carried out at 30° C. with an applied DC potential of 10 mV with the current monitored over time. EIS measurements were taken at open-circuit voltage just before applying the bias potential and after the current reached steady state.

Full cell characterizations utilized a lithium metal anode, a glass fiber polymer electrolyte composite, and a lithium iron phosphate (LFP) cathode. The cathode was prepared as previously reported with a weight ratio of 80/10/10 of LifePO₄, Super P carbon black, and poly(vinylidene fluoride)(PVDF)(M. Lehmann et al., J Electrochem Soc, 2020, 167(7), 070539-070547). The final active material loading is estimated to be 2.04 mg/cm². The samples were cycled at room temperature (15-24° C.) at 0.05C for 3 cycles, 0.1C for 120 cycles, and then 0.2C for the remainder of the testing.

### Synthesis of a TFSI-Based SICP Electrolyte

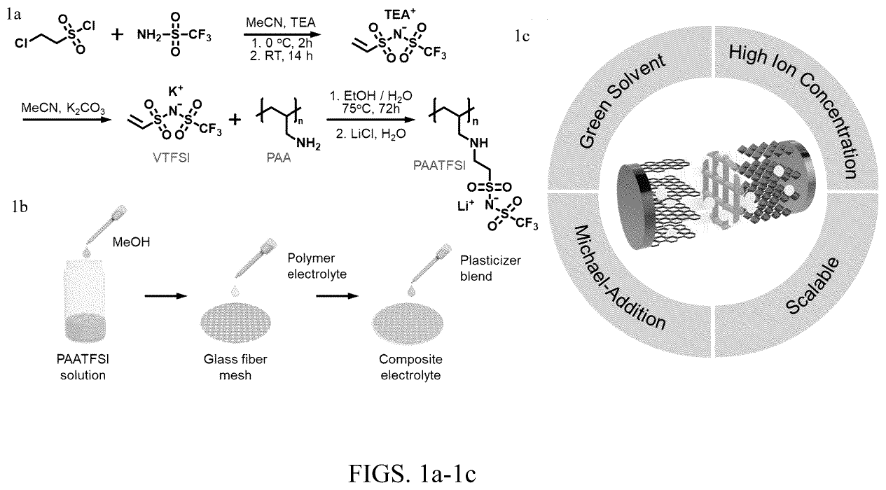

A relatively underutilized monomeric TFSI anion is vinyl sulfonyl(trifluoromethane sulfonyl)imide (VTFSI)(FIG. 1a), which was first reported by Armand et al. in 1998 (EP0850920A2). While this monomer has been tested for the fabrication of polymer electrolytes, its use has been limited. A possible reason is that the homopolymerization or copolymerization of the VTFSI monomer is sluggish, and only low molecular weight polymers have been reported under a variety of reaction conditions

The following work demonstrates the versatility of the VTFSI monomer to synthesize a SICP using aza-Michael addition. As shown in FIG. 1a, a novel SICP was synthesized utilizing commercially available poly(allylamine)(PAA) as the Michael donor and VTFSI as the Michael acceptor. The synthesis uses mild solvents and reaction conditions to yield a SICP with a single TFSI anion per polymer repeat unit (PAATFSI). PAATFSI exhibits a lower glass transition temperature than PSTFSI and PMTFSI homopolymers, thereby resulting in a several orders of magnitude increase in Li-ion conductivity of the dry polymer electrolyte. As shown in FIG. 1b, to further adapt PAATFSI for practical applications, the polymer was blended with two different plasticizers, a low molecular weight poly(ethylene glycol) and an ethylene carbonate/propylene carbonate (EC/PC) blend. The resulting single-ion conducting electrolytes were evaluated in Li-metal batteries. PAATFSI plasticized with the carbonate solvent mixture exhibits stable room temperature cycling in a Li metal symmetric cell. The present work demonstrates a route for the synthesis of TFSI-based SICPs from amine-based starting materials using facile aza-Michael addition and their use for beyond Li-ion applications. FIG. 1c shows some of the benefits of the PAATFSI polymer electrolyte.

### Results and Discussion

A unique polymer electrolyte, PAATFSI, was synthesized by the Michael addition of VTFSI with commercially available PAA (~60,000 g/mol). The VTFSI was synthesized via a single-step reaction involving the simultaneous elimination reaction (E2) of 2-chloroethanesulfonyl chloride with the addition of trifluoromethanesulfonamide (TFSA) to the sulfonyl group, facilitated by the base, triethylamine (TEA)(FIG. 1a). The resultant vinyl monomer in protonated TEA form was then converted to potassium form to yield an off-white powder. The addition of VTFSI to the amine-based polymer utilized non-toxic solvents of water and ethanol under mild conditions (75° C., 3 days) to yield a polymer electrolyte with a single TFSI moiety for each repeat unit (FIG. 1a). The polymer contains a relatively high ion concentration (3.31 mmol/g) compared to other homopolymer electrolytes (PMTFSI=3.00 mmol/g, PSTFSI=3.15 mmol/g) and can be easily incorporated into a glass mesh to form a composite (FIG. 1b).

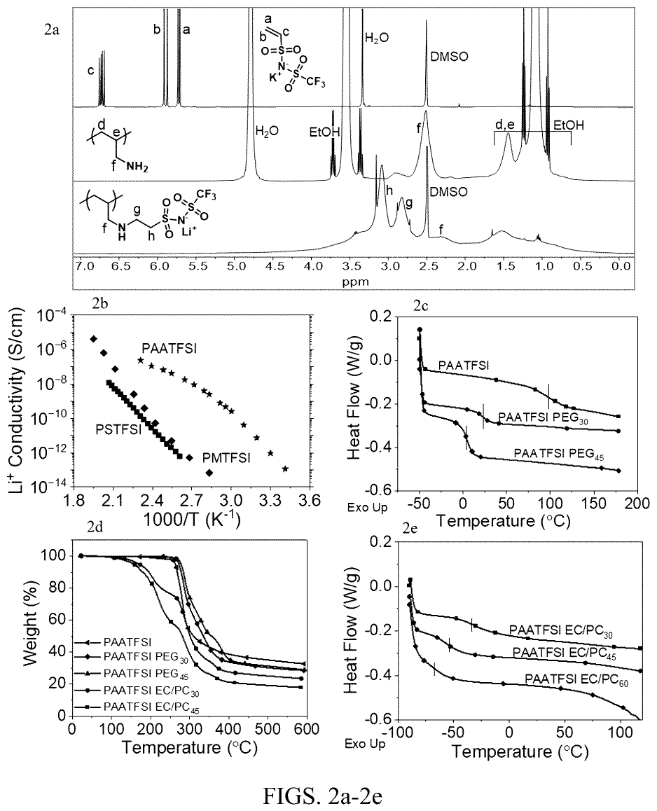

As shown in FIG. 2a, ¹H Nuclear Magnetic Resonance (¹H NMR) spectra of PAATFSI shows the appearance of two new peaks at 2.83 and 3.08 ppm corresponding to the ethylene protons of VTFSI. Comparing the ¹H NMR spectra of PAA and PAATFSI, the ‘f’ peak originally located at δ=2.51 ppm in the PAA spectrum shifts upfield in the PAATFSI spectrum, thus indicating a shift in the electron density of the adjacent amine functional group. Additionally, the ¹H NMR spectrum confirms that the excess VTFSI has been successfully removed, as indicated by the absence of vinyl peaks in the PAATFSI spectrum. To confirm the ratio of VTFSI added to PAA, ¹⁹F NMR was performed on the polymer electrolyte. By comparing the molar ratio of TFSI groups in PAATFSI to an internal standard (TFSA), it was herein confirmed that 98% of the primary amines of PAA reacted with a single VTFSI monomer. Other experiments attempted to add a second TFSI moiety to each repeat unit by increasing the VTFSI equivalents in the reaction, but no attachment of additional TFSI groups was observed based on 19F NMR analysis and the lack of polymer mass gain. A possible reason for the foregoing observation is that the addition of a second bulky anion may be unfavorable for a polymer with the amine close to the backbone due to steric hindrance.

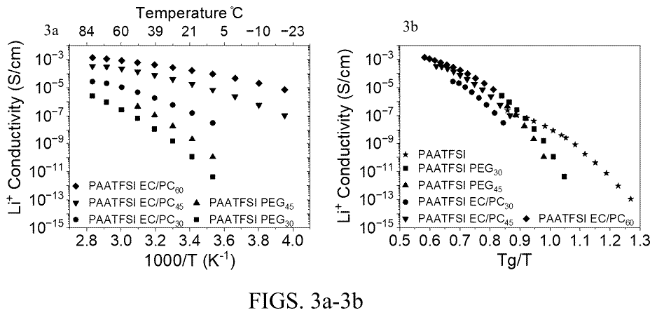

As shown in FIG. 2b, the Li-ion conductivity of PAATFSI was evaluated and compared to that of other single-ion conducting polymers in the dry state. The Li-ion conductivity of PAATFSI (2.4×10⁻⁹ S/cm at 80° C.) is over 4 orders of magnitude higher than similar homopolymer electrolytes (C. Gainaru et al., Macromolecules 2023, 56 (15), 6051-6059). The higher Li-ion conductivity of PAATFSI is mainly due to its lower glass transition temperature (T_{g}). As shown by FIG. 2c, the T_{g} of PAATFSI is 99° C. while those of PSTFSI and PMTFSI are 234° C. and 162° C., respectively. The Li-ion conductivity of PAATFSI at T_{g} is ~10⁻⁸ S/cm, revealing about 6 orders of magnitude decoupling of conductivity from the polymer structural relaxation (in a coupled system, conductivity at T_{g} is expected to be ~10⁻¹⁴ S/cm²; see, e.g., V. Bocharova et al., Macromolecules 2020, 53 (11), 4141-4157). PAATFSI has a similar degree of decoupling as PSTFSI and is about 2 orders of magnitude higher than PMTFSI. The significantly higher Li-ion conductivity of PAATFSI demonstrates the higher practical relevance of this electrolyte over PSTFSI and PMTFSI, and the facile functionalization by Michael addition can provide a potential path towards improving the conductivity of dry polymer electrolytes. To further improve the Li-ion conductivity, initial experiments added a low molecular weight poly(ethylene glycol) (PEG1000) as a plasticizer to PAATFSI at two different weight ratios of 30 and 45% PEG1000 to yield the blends denoted as PAATFSI PEG30 and PAATFSI PEG₄₅, respectively. The T_{g} of the PEG-PAATFSI blends decreased from 99° C. for PAATFSI to 23° C. and 4° C. for PAATFSI PEG30 and PAATFSI PEG45, respectively (FIG. 2c, Table 1), while degradation temperature Ta increased slightly due to the high thermal stability of PEG (FIG. 2d). As shown in FIG. 3a and Table 1, with the addition of the low molecular weight PEG polymer, the Li-ion conductivity at 30° C. increased from 9.6×10⁻¹³ S/cm for PAATFSI to 1.9×10⁻⁸ S/cm for PAATFSI PEG₄₅. While this is a marked increase in conductivity, it remains low for any practical applications.

TABLE 1
Li-ion conductivity and glass transition temperature of samples.

| | T_{g} | Li⁺ Conductivity | Li⁺ Conductivity |
|---|---|---|---|
| Sample | (° C.) | (S/cm, 30° C.) | (S/cm, 80° C.) |
| PAATFSI | 98.7 | 9.6 × 10⁻¹³ | 2.4 × 10⁻⁹ |
| PAATFSI PEG₃₀ | 23.5 | 1.5 × 10⁻⁹ | 9.0 × 10⁻⁷ |
| PAATFSI PEG₄₅ | 4.1 | 1.9 × 10⁻⁸ | — |
| PAATFSI EC/PC₃₀ | −34.1 | 6.0 × 10⁻⁷ | 2.1 × 10⁻⁵ |
| PAATFSI EC/PC₄₅ | −53.7 | 3.9 × 10⁻⁵ | 3.0 × 10⁻⁴ |
| PAATFSI EC/PC₆₀ | −67.7 | 2.7 × 10⁻⁴ | 1.4 × 10⁻³ |

Carbonate solvents are known for their high dielectric constants that enable high conductivity of lithium salts. In the present work, PAATFSI was plasticized with an EC/PC (1:1 v/v) solvent mixture. As shown in FIG. 2e and Table 1, the addition of EC/PC to PAATFSI had a significant impact on the T_{g} of the blends, decreasing the T_{g} of PAATFSI EC/PC₆₀ to −68° C. This significant reduction can be attributed to the very low T_{g} of the carbonate solvents, which is known to be approximately −112° C. for PC. While the addition of a small molecule plasticizer greatly reduces T_{g}, they are also more volatile. The evaporation of EC and PC is observed in the TGA profile of the blends, beginning at 150° C. (FIG. 2d), thus indicating that the operation temperature should be below 100° C. or preferably below 80° C. Upon plasticization with EC/PC, the Li-ion conductivity increased three orders of magnitude, from 1.9×10⁻⁸ S/cm for PAATFSI PEG45 to 3.9×10⁻⁵ S/cm for PAATFSI EC/PC₄₅ or 2.7×10⁻⁴ S/cm for PAATFSI EC/PC₆₀ at 30° C. (FIG. 3a, Table 1), which comparable to other quasi-solid-state polymer electrolytes. Also, PAATFSI EC/PC₄₅ and PAATFSI EC/PC₆₀ exhibit a Li-ion conductivity of 3.0×10⁻⁴ S/cm and 1.4×10⁻³ S/cm at 80° C. The Li-ion conductivity enhancement of PAATFSI is mainly attributed to the reduction in T_{g} as demonstrated by the overlap of ionic conductivities upon temperature normalization to T_{g} (FIG. 3b). For dry PAATFSI, most of the data points are to the right (>1.0 T_{g}/T), indicating that the measured conductivity is below T_{g} in this region. Once above T_{g} (<1.0 T_{g}/T), the data points meet those of the plasticized samples. The results indicate that the T_{g} reduction of PAATFSI caused by the presence of plasticizer has a significant influence on conductivity enhancement and highlights the need for polymer electrolytes that have a low T_{g} in the dry state or are tuned by plasticization.

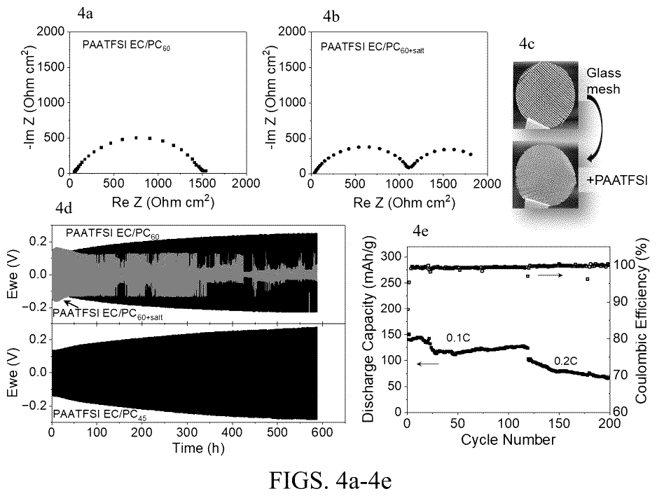

To perform electrochemical characterization of the polymer electrolyte in a coin cell configuration, the base polymer PAATFSI was dissolved in a small amount of methanol and drop cast into a 25 μm thick glass fiber mesh, then thoroughly dried (FIG. 1b). As shown in the photographs in FIG. 4c, even though PAATFSI itself is a relatively brittle polymer at room temperature, when incorporated into the glass mesh, a free-standing flexible membrane was formed. The composite membrane was then plasticized with the appropriate amount of EC/PC during cell assembly and heated at 50° C. for several hours to ensure uniform distribution of plasticizer. As shown by the data in FIG. 4d, both PAATFSI EC/PC₄₅ and PAATFSI EC/PC₆₀ with the glass fiber mesh show stable stripping/plating in a lithium symmetric cell at 0.1 mA/cm² current density for over 500 hours at 30° C. with no short circuit observed. Notably, the overpotential of the PAATFSI EC/PC₄₅ sample is slightly higher than the PAATFSI EC/PC₆₀ sample due to its lower Li-ion conductivity. The overpotential value of the symmetric cells is a combination of several factors, including the bulk ionic conductivity of the electrolyte, the interfacial resistance between the polymer and Li metal, and the charge transfer resistance. As shown in FIG. 4a, the Nyquist plot of PAATFSI EC/PC₆₀ before symmetric cell cycling shows a large semicircle that is 1500 Ω cm², which is indicative of a large interfacial resistance with Li. The left touchdown of the semicircle on the x-axis is indicative of a relatively small bulk polymer electrolyte resistance (FIG. 4a).

As an attempt to decrease the interfacial resistance, next experiments added a small amount of LiTFSI salt to PAATFSI EC/PC₆₀ to determine if the addition of salt was beneficial to the polymer electrolyte's performance (PAATFSI EC/PC₆₀+salt). The ionic conductivity of the sample with added salt increased slightly to 3.6×10⁻⁴ S/cm from 2.7×10⁻⁴ S/cm for PAATFSI EC/PC₆₀ at 30° C. To further evaluate the influence of the added salt, the Li⁺ transport number of the PAATFSI EC/PC₆₀₍₊ₛₐₗₜ₎ samples was measured. The Li⁺ transport number of PAATFSI EC/PC₆₀₊ₛₐₗₜ decreased to 0.53 from 0.97 for PAATFSI EC/PC₆₀, similar to that of previously reported values of single-ion conductors that contain free salt, but still notably higher than salt-in-polymer or liquid electrolytes with typical Li⁺ transport numbers in the range of 0.05 to 0.3. The Nyquist plot of PAATFSI EC/PC₆₀₊ₛₐₗₜ shows a lower interfacial resistance than PAATFSI EC/PC₆₀ (the first semicircle in FIG. 4b).

However, these apparent positive ion transport characteristics associated with the addition of free Li salt cannot offset the negative impacts. First, the Li-ion conductivity actually decreased. Li-ion conductivity is equal to total ionic conductivity × cation transport number. In PAATFSI EC/PC₆₀, the Li-ion conductivity is 2.6×10⁻⁴ S/cm. In contrast, the Li-ion conductivity of PAATFSI EC/PC₆₀₊ₛₐₗₜ decreased to 1.9×10⁻⁴ S/cm. Further, the charge transfer resistance of the Li symmetric cell of PAATFSI EC/PC₆₀₊ₛₐₗₜ is large (nearly 1000 Ohm), characterized by the second semicircle (low frequency semicircle) in FIG. 4b. These two negative factors led to an increased initial overpotential in the symmetric cell cycling of the PAATFSI EC/PC₆₀₊ₛₐₗₜ cell compared to PAATFSI EC/PC₆₀ (FIG. 4d). The higher initial overpotential of PAATFSI EC/PC₆₀₊ₛₐₗₜ in the symmetric cell quickly decreases to 0.1 V, below that of PAATFSI EC/PC₆₀, which suggests significant Li electrode roughening or soft shorting occurred. Additionally, the PAATFSI EC/PC₆₀₊ₛₐₗₜ sample began to exhibit unstable cycling after 100 h of stripping and plating. These findings indicate that the addition of a salt to a single-ion conductor can aid in reducing the interfacial resistance between the polymer and Li metal but can have negative effects that lead to early dendrite formation.

PAATFSI EC/PC₆₀ was further characterized in a full cell with a LFP cathode. As shown by the data in FIG. 4e, PAATFSI EC/PC₆₀ demonstrates stable cycling at 0.1C for 120 cycles with a specific capacity of 125 mAh/g and capacity retention of 89%, which is comparable to or better than other single-ion conducting quasi-solid-state polymer electrolytes operating at or below 25° C. Plateaus at about 3.53 V were observed for charge and 3.34 V for discharge, representing the typical redox process of the LFP electrode. There is some variation in the cycling profile due to wide temperature fluctuations in the laboratory (average temperature of 20° C.). At 120 cycles, the rate was increased to 0.2C, where a decrease in the capacity is observed, which indicates that the cell needs further optimization to operate at higher C rates.

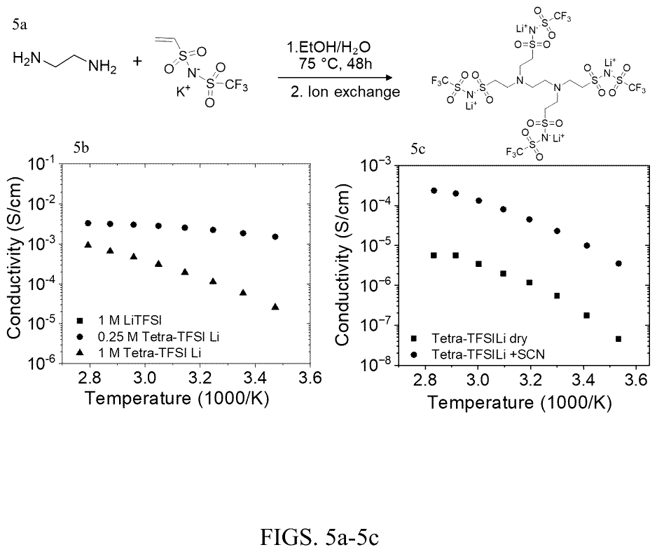

The conductivity of Tetra-TFSILi (DA-TFSI) as a liquid electrolyte was measured at a 0.25 M (equivalent to 1 M LITFSI) and a 1 M salt concentration in an ethylene carbonate/propylene carbonate/dimethyl carbonate (EC/PC/DMC 1:1:1 v/v/v) solvent mixture. As shown in FIG. 5a, the conductivity of 0.25 M DA-TFSI is similar to 1 M LiTFSI electrolyte solution, but with a significantly higher transport number. The structure of Tetra-TFSILi (shown as the product in the scheme in FIG. 5a) provides fast ion dynamics, similar to a traditional liquid electrolyte to achieve high conductivity, but the bulky structure slows the motion of the anion to enable a high transference number. The 1 M DA-TFSI electrolyte solution is highly viscous; thus, the ionic conductivity is reduced compared to the 0.25 M DA-TFSI solution.

FIG. 5b is a graph showing the ionic conductivity as a function of temperature of LiTFSI and Tetra-TFSILi in carbonate-based electrolyte. FIG. 5c is a graph showing the ionic conductivity as a function of temperature of Tetra-TFSILi in a crosslinked polyethylene oxide membrane dry and plasticized with 50 wt % succinonitrile. FIG. 5c shows the conductivity of Tetra-TFSILi within a crosslinked polyethylene oxide membrane, which demonstrates reasonable conductivity in the dry state and a significantly improved conductivity when plasticized with 50 wt % succinonitrile.

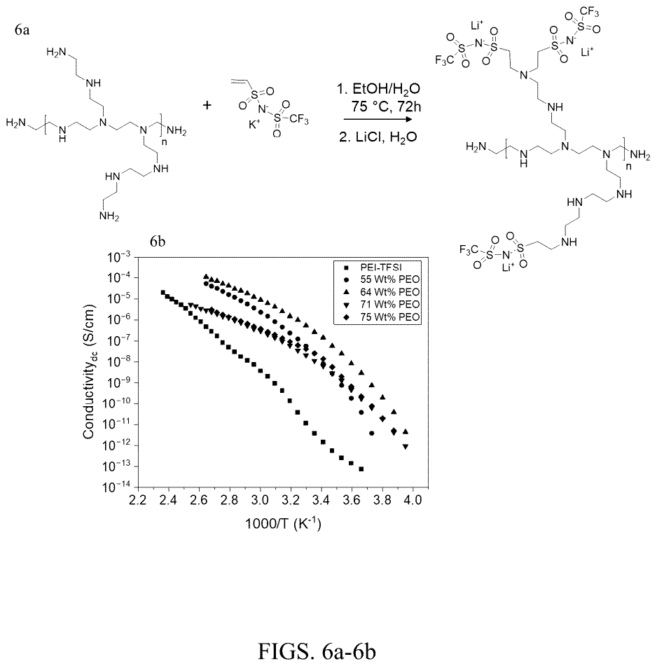

FIG. 6a shows a schematic of the synthesis of the polymer electrolyte PEI-TFSILi. FIG. 6b shows the ionic conductivity of dry PEI-TFSILi and PEI-TFSILi lightly crosslinked with poly(ethylene glycol) diglycidyl ether (PEO 2000).

### CONCLUSION

Single-ion conducting polymer electrolytes were synthesized via a Michael addition reaction under mild reaction conditions between an amine-containing polymer and a vinyl TFSI anion. The resulting polymer electrolyte (PAATFSI) exhibits several orders of magnitude higher Li-ion conductivity than similar TFSI-based single-ion conducting homopolymers. When plasticized with a carbonate-based solvent, the Li-ion conductivity reached 2.7×10⁻⁴ S/cm at 30° C. (PAATFSI EC/PC₆₀). The T_{g} of plasticized PAATFSI is influenced by plasticizer type but significantly decreases with increasing plasticizer amount to −68° C. for PAATFSI EC/PC₆₀. The highly conductive polymer electrolyte provides stable cycling in lithium metal symmetric and full cells. The synthesis method demonstrated here opens an avenue for the synthesis of new TFSI-based polymers and small molecule anions that have many potential applications in electrochemical storage devices.

While there have been shown and described what are at present considered the preferred embodiments of the invention, those skilled in the art may make various changes and modifications which remain within the scope of the invention defined by the appended claims.

What is claimed is:

1. An electrolyte compound having the following structure: 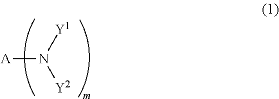
wherein:
A is a linear, branched, or cyclic hydrocarbon group containing at least one carbon atom and optionally containing one or more heteroatoms selected from N, O, and S;
Y¹ and Y² are independently selected from H atom and a sulfonylimide group of the formula 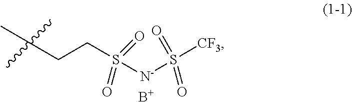
wherein B⁺ is an alkali metal ion;
wherein at least one of Y¹ and Y² is said sulfonylimide group; and
m is an integer of at least 1.

2. The electrolyte compound of claim 1, wherein m is an integer of at least 2.

3. The electrolyte compound of claim 1, wherein m is an integer of at least 3.

4. The electrolyte compound of claim 1, wherein m is an integer of at least 4.

5. The electrolyte compound of claim 1, wherein said linear, branched, or cyclic hydrocarbon group contains at least 4 carbon atoms and m is an integer of at least 10.

6. The electrolyte compound of claim 1, wherein said linear, branched, or cyclic hydrocarbon group consists of carbon and hydrogen atoms and no heteroatoms.

7. The electrolyte compound of claim 1, wherein said linear, branched, or cyclic hydrocarbon group contains at least one O atom.

8. The electrolyte compound of claim 7, wherein m is 1 and said linear, branched, or cyclic hydrocarbon group has the formula R′O(CH₂)ₚ— wherein R′ is H or a hydrocarbon (R) containing 1-12 carbon atoms and optionally containing one or more O atoms, and p is an integer of 1-12, which results in the electrolyte compound having the following formula:

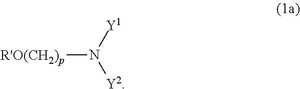

9. The electrolyte compound of claim 1, wherein said linear, branched, or cyclic hydrocarbon group in A contains at least one N atom.

10. The electrolyte compound of claim 9, wherein the electrolyte compound has the following formula: 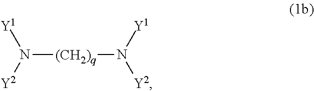
wherein q is an integer of 1-12.

11. The electrolyte compound of claim 1, wherein said linear, branched, or cyclic hydrocarbon group in A contains at least two N atoms.

12. The electrolyte compound of claim 1, wherein said linear, branched, or cyclic hydrocarbon group in A contains at least three N atoms.

13. The electrolyte compound of claim 1, wherein said linear, branched, or cyclic hydrocarbon group in A is a polymeric hydrocarbon group, and wherein m is at least 10.

14. The electrolyte compound of claim 13, wherein the polymeric hydrocarbon group is selected from the group consisting of poly(allylamine), polyethyleneimine (PEI), poly(vinylamine), polylysine, poly(4-aminostyrene), and PAMAM dendrimers.

15. An electrolyte solution comprising an electrolyte compound dissolved in a solvent, wherein the electrolyte compound has the following structure: 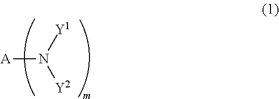
wherein:
A is a linear, branched, or cyclic hydrocarbon group containing at least one carbon atom and optionally containing one or more heteroatoms selected from N, O, and S;
Y¹ and Y² are independently selected from H atom and a sulfonylimide group of the formula 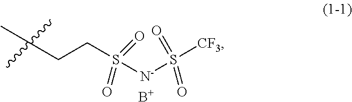
wherein B⁺ is an alkali metal ion;
wherein at least one of Y¹ and Y² is said sulfonylimide group; and
m is an integer of at least 1.

16. The electrolyte solution of claim 15, wherein the solvent is a carbonate solvent.

17. The electrolyte solution of claim 15, wherein the solvent is present in the electrolyte solution in a concentration of 10-200 wt % by weight of the solvent to electrolyte compound.

18. A lithium-ion battery comprising:
a) an anode;
(b) a cathode; and
(c) an electrolyte solution in contact with said anode and cathode and comprising an electrolyte compound dissolved in or plasticized with a solvent, wherein the electrolyte compound has the following structure: 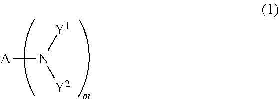
wherein:
A is a linear, branched, or cyclic hydrocarbon group containing at least one carbon atom and optionally containing one or more heteroatoms selected from N, O, and S;
Y¹ and Y² are independently selected from H atom and a sulfonylimide group of the formula 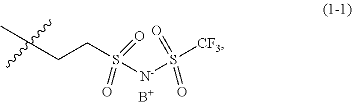
wherein B⁺ is an alkali metal ion;
wherein at least one of Y¹ and Y² is said sulfonylimide group; and
m is an integer of at least 1.

19. The lithium-ion battery of claim 18, wherein the solvent is a carbonate solvent.

20. The lithium-ion battery of claim 18, wherein the solvent is present in the electrolyte solution in a concentration of 10-200 wt % by weight of solvent to electrolyte compound.
